(19) United States
(12) Patent Application Publication
(10) Pub. No.: US 2004/0158675 A1
(43) Pub. Date: Aug. 12, 2004

(54) Memory system and control method therefor

(75) Inventor: Yukitoshi Hirose, Chou-ku (JP)

Correspondence Address: SUGHRUE MION, PLLC, 2100 PENNSYLVANIA AVENUE, N.W., SUITE 800, WASHINGTON, DC, 20037, US

(73) Assignee: ELPIDA MEMORY, INC.

(21) Appl. No.: 10/724,164

(22) Filed: Dec. 1, 2003

(30) Foreign Application Priority Data
Dec. 2, 2002 (JP) 2002-349867

(51) Int. Cl. G06F 12/00

(52) U.S. Cl. 711/115; 711/112

(57) ABSTRACT

A memory system according to the present invention copies data stored in memory modules to a hard disk device at each predetermined period, in replacing an arbitrary memory module, switches a bus from a unidirectional bus to a bi-directional bus, and at the time when an access to a memory module to be replaced is requested, accesses a storage area in the hard disk corresponding to an address space of the memory module. In addition, the memory system copies data corresponding to the address space of the memory module to be replaced from the hard disk device to a storage, and at the time when an access to the memory module is requested, accesses a storage area of the storage corresponding to the address space. Moreover, the memory system short-circuits bus connection which is disconnected by removing the memory module to be replaced.

### BACKGROUND OF THE INVENTION

1. Field of the Invention

The present invention relates to a memory system which is used in an information processing apparatus, and in particular to a memory system in which a bus is constituted by connecting a plurality of memory modules in series in the form of one-stroke writing.

2. Description of the Prior Art

In recent years, in the field of an information processing apparatus such as a personal computer or a server computer, there is an increasing need for a higher speed of access and a larger storage capacity of a memory system in accordance with an increase in speed of processing by a CPU and an increase in size of a program.

As a memory system with a large storage capacity, there is generally known a structure as shown in FIG. 1 provided with a plurality of memory modules mounted with a plurality of semiconductor memories such as a RAM and a ROM (e.g., see Japanese Patent Laid-Open No. 2-278353).

The memory system shown in FIG. 1 has a plurality of (four in the figure) memory modules 102 (102₁ to 102₄) and memory controller 103 which controls an operation for accessing memory modules 102 from CPU 101. The respective memory modules 102 and memory controller 103 are connected to each other by a bus. The bus is a line which is commonly used for transmitting data and an address signal bi-directionally between a memory controller and a memory module. Memory modules 102 are connected to the bus in parallel with each other via stubs (branching means) such as connectors. Therefore, for example, even if a failed memory module (memory module 102₂ in FIG. 1) is removed as shown in FIG. 1, the connection between the other memory modules 102₁, 102₃, and 102₄ and the memory controller 103 is maintained.

Incidentally, in the information processing apparatus in recent years, as a result of the increase in speed of processing in a CPU as described above, a transmission speed of data and an address signal transmitted using a bus has also been increased. When a high-speed signal is transmitted using the bus, reflection or the like occurs in a stub or at a bus end, and a signal waveform to be received in each memory module is distorted. Thus, correct information cannot be received.

In order to solve such a problem, there is proposed a structure of a memory system as shown in FIG. 2 in which a plurality of memory modules are connected in series in a ring shape via buffer sections which are provided in the respective memory modules (e.g., see Ivan Tving, “Multiprocessor interconnection using SCI”, DTH ID-E 579., pp 93-94, 28 August, 1994. Internet URL:

http://www.SCIzzL.com/HowToGetSCIdox.html).

FIG. 2 shows a structure called a RAMLINK memory system, which eliminates a stub or a bus end to suppress the occurrence of reflections or the like and realizes high-speed transmission by connecting memory controller 113 and a plurality of (four in the figure) memory modules 112 (112₁ to 112₄) in the form of one-stroke writing. Usually, in the RAMLINK memory system, a unidirectional bus, in which a transmission direction of a signal is fixed only in one direction in order to increase efficiency of use of the bus, is adopted. Therefore, in the case in which a signal is sent and received bi-directionally between memory controller 113 and memory modules 112, two unidirectional buses having opposite transmission directions only have to be provided. Note that, although a state in which memory module 112₂ is removed is shown in FIG. 2, in an actual memory system, a memory module is not removed unless a failure occurs.

For example, in a server computer connected to a network such as the Internet, since it is not allowed to turn off an apparatus power supply even for a short time, a hot swap (or hot plug) function for making it possible to replace a module while keeping the apparatus power supply on is required.

In the above-described RAMLINK system, since the bus structure is maintained by connecting the plurality of memory modules in the form of one-stroke writing, the bus is disconnected if even one memory module is removed as shown in FIG. 2. In other words, in the case in which a failure or the like occurs in a certain memory module, since the apparatus power supply has to be turned off to replace the memory module, the hot swap function cannot be realized.

In order to cope with such a problem, for example, as shown in FIG. 3, it is possible to adopt a structure in which the RAMLINK memory system shown in FIG. 2 is provided in two systems, one of which is used as a main system to be usually used and the other is used as a spare mirror system to which data in the main system is copied. With such a structure, even if a failure occurs in the main system, hot swap of a memory module in which the failure occurs becomes possible by switching an operation of the memory controller for accessing the mirror system.

However, in the structure shown in FIG. 3, since the mirror system is required to have the same storage capacity as the main system, the number of memory modules increases to make the memory system expensive, and a mounting area thereof is increased to make the memory system large.

### SUMMARY OF THE INVENTION

It is therefore an object of the present invention to provide a memory system, which realizes the hot swap function while suppressing the increase in a mounting area and a price of the memory system, and a control method therefor.

In order to attain the above-described object, in the present invention, the memory system copies data stored in memory modules to a hard disk device at each predetermined period, switches a bus from a unidirectional bus to a bi-directional bus when an arbitrary memory module is replaced, detects an address space of the memory module to be replaced, and accesses a memory area in the hard disk device corresponding to the detected address space when an access to the memory module is requested. Consequently, the hot swap function can be realized without increasing the number of memory modules.

In addition, in replacing the arbitrary memory module, the memory system detects an address space of the memory module, copies corresponding data in the address space to a storage from the hard disk device, and at the time when an access to the memory module to be replaced is requested, accesses a memory area of the storage corresponding to the detected address space to thereby access the storage which is accessible at a high speed compared with the hard disk device. Consequently, time for accessing the memory area corresponding to the memory module to be replaced can be reduced.

Moreover, in replacing the arbitrary memory module, the memory system short-circuits a bus to be disconnected by removing the memory module, detects an address space of the memory module to be replaced, copies data corresponding to the detected address space to the storage from the hard disk device, and accesses a memory area of the storage corresponding to the address space at the time when an access to the memory module to be replaced is requested. Consequently, since the memory system can be operated with the unidirectional bus even at the time of replacement of a memory module, decrease in efficiency of use of the bus is prevented.

Therefore, the memory system, which realizes the hot swap function while suppressing the increase in a mounting area and a price, and an information processing apparatus mounted with the same can be obtained.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a block diagram showing a structure of a memory system of a first conventional example;

FIG. 2 is a block diagram showing a structure of a memory system of a second conventional example;

FIG. 3 is a diagram showing a structure of a memory system of a third conventional example;

FIG. 4 is a block diagram showing a structure of a first embodiment of a memory system of the present invention;

FIG. 5 is a circuit diagram showing a structure of a buffer section provided in a memory module shown in FIG. 4;

FIG. 6A is a circuit diagram showing a structure of a first memory controller shown in FIG. 4;

FIG. 6B is a circuit diagram showing a structure of a second memory controller shown in FIG. 4;

FIG. 7 is a block diagram showing a bus operation in the case in which a failure has occurred in a memory module provided in the memory system shown in FIG. 4;

FIG. 8 is a flowchart showing an operation of the first embodiment of the memory system of the present invention;

FIG. 9 is a block diagram showing a structure of a second embodiment of the memory system of the present invention;

FIG. 10 is a block diagram showing a structure of a third embodiment of the memory system of the present invention;

FIG. 11 is a block diagram showing a structure of a fourth embodiment of the memory system of the present invention;

FIG. 12 is a block diagram showing a structure of a fifth embodiment of the memory system of the present invention;

FIG. 13A is a circuit diagram showing a structure of a buffer section provided in a memory module shown in FIG. 12;

FIG. 13B is a circuit diagram showing a structure of a buffer section provided in a memory module shown in FIG. 12;

FIG. 14 is a circuit diagram showing a structure of a first memory controller shown in FIG. 12;

FIG. 15 is a flowchart showing an operation of the fifth embodiment of the memory system of the present invention;

FIG. 16 is a block diagram showing a structure of a sixth embodiment of the memory system of the present invention;

FIG. 17 is a block diagram showing a structure of a first memory controller shown in FIG. 16;

FIG. 18 is a flowchart showing an operation of the sixth embodiment of the memory system of the present invention;

FIG. 19 is a block diagram showing a structure of a seventh embodiment of the memory system of the present invention;

FIG. 20 is a block diagram showing a structure of an eighth embodiment of the memory system of the present invention;

FIG. 21 is a main part enlarged view showing a structure of a connector shown in FIG. 20; and

FIG. 22 is a flowchart showing an operation of the eighth embodiment of the memory system of the present invention.

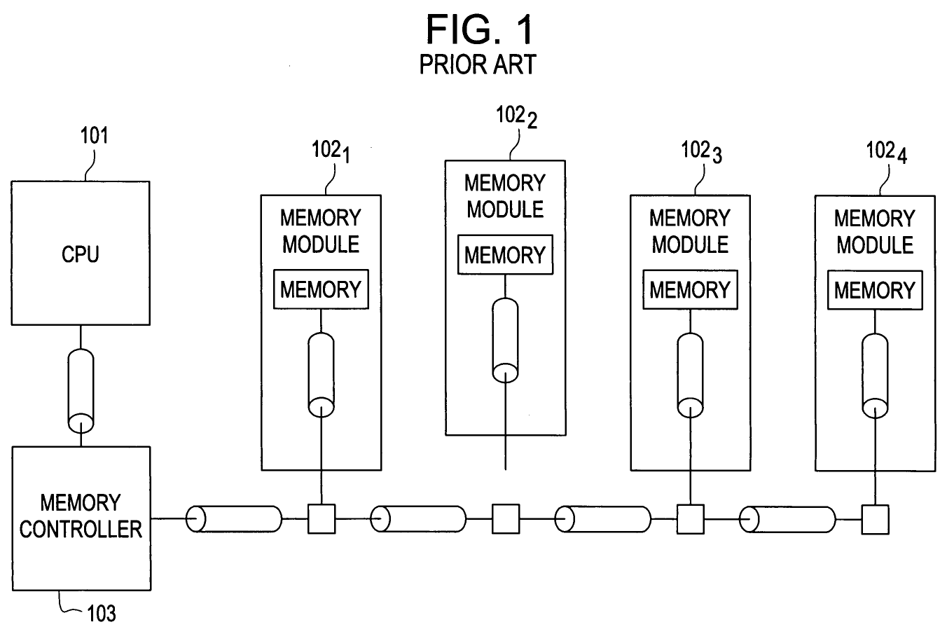

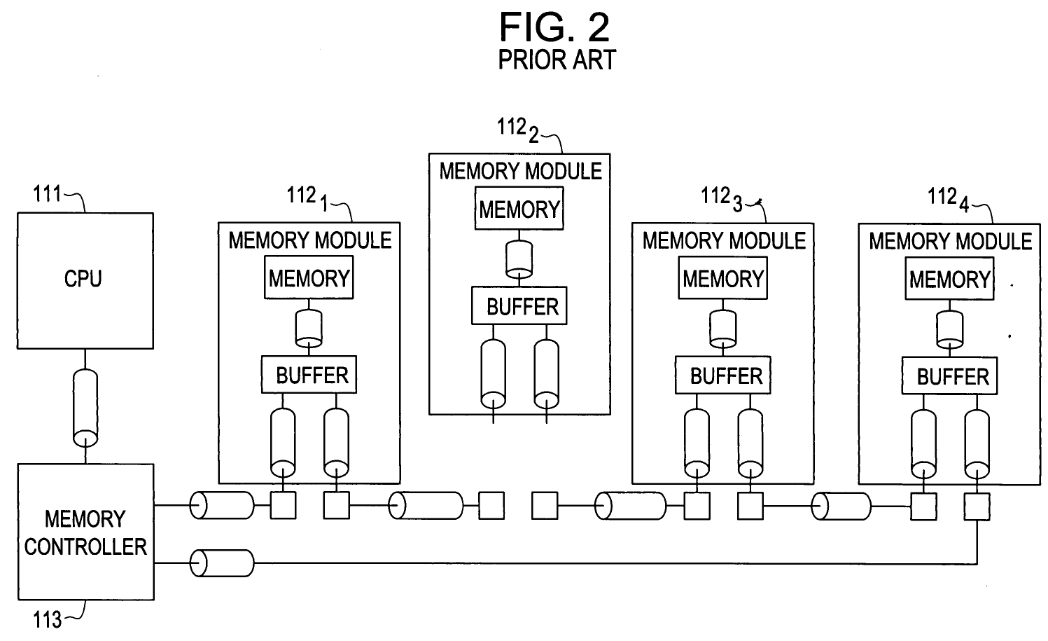

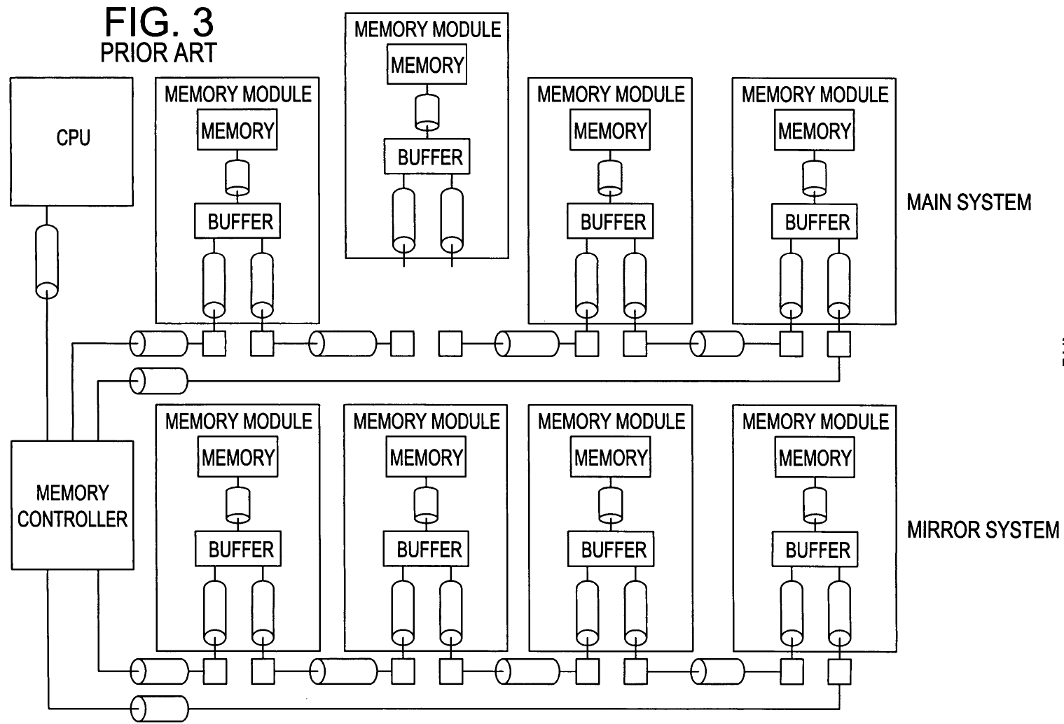

### DETAILED DESCRIPTION OF THE PREFERRED EMBODIMENTS

(First Embodiment)

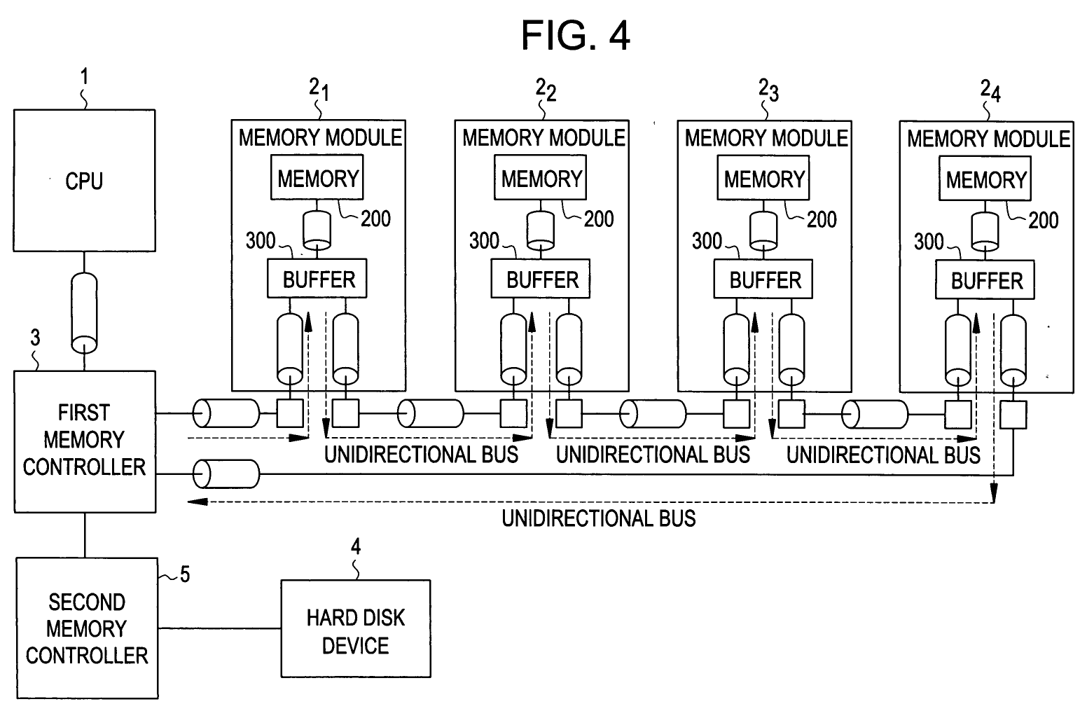

As shown in FIG. 4, a memory system of a first embodiment includes a plurality of (four in the figure) memory modules 2 (2₁ to 2₄), first memory controller 3 which controls an access operation from CPU 1 to memory modules 2, hard disk device 4 to which data in all memory modules 2 are copied (mirrored), and second memory controller 5 which controls an access operation from CPU 1 to hard disk device 4, and has a structure in which the plurality of memory modules 2 and first memory controller 3 are connected in series in a ring shape. Memory modules 2 include a plurality of semiconductor memories 200 in which data is stored, and buffer sections 300 for sending and receiving a signal between a bus and the semiconductor memories. Although FIG. 4 shows the memory system including four memory modules 2₁ to 2₄, the number of the memory modules is not limited to four, and any number of the memory modules may be provided. In addition, buffer section 300 is not required to be provided independently but may be provided in semiconductor memory 200.

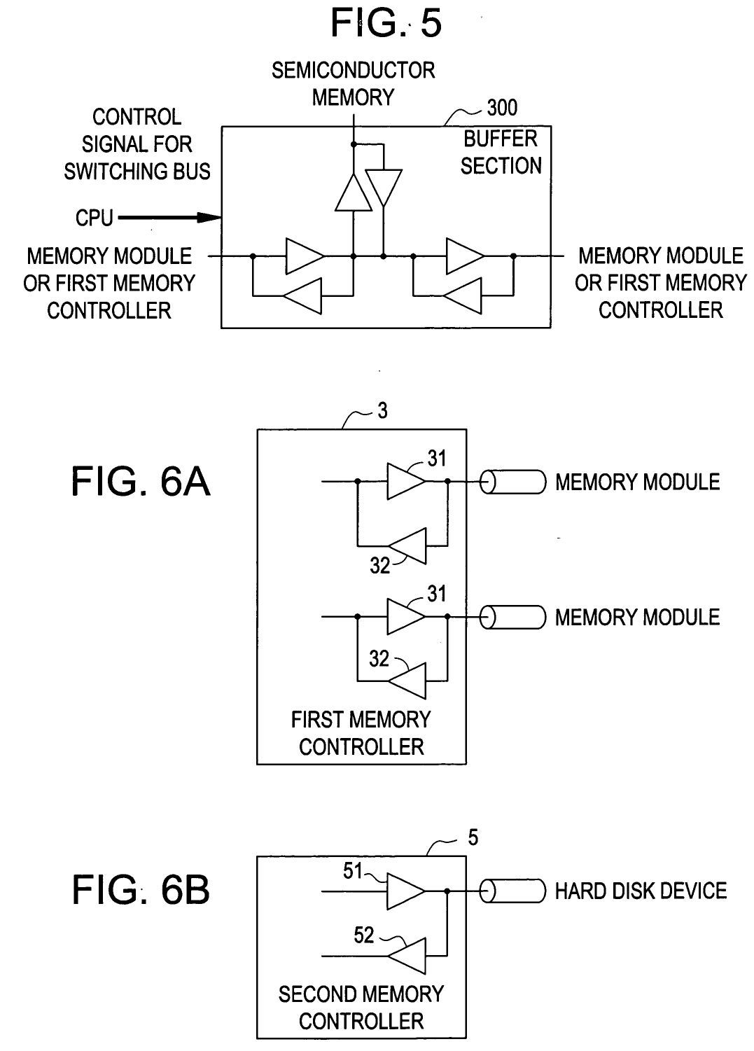

As shown in FIG. 5, buffer section 300 is provided with three sets of two buffer circuits with input ends and output ends thereof connected with each other, and is constituted so as to be capable of sending and receiving a signal bi-directionally to and from the semiconductor memory 200 in a memory module, to which buffer section 300 belongs, and adjacent memory module 2 or first memory controller 3, respectively.

As shown in FIG. 6A, first memory controller 3 is provided with two sets of buffer circuits 31 and 32 in which input ends and output ends are connected to each other, and is constituted so as to be capable of sending and receiving a signal bi-directionally to and from the adjacent memory module 2. In addition, as shown in FIG. 6B, second memory controller 5 is provided with driver circuit 51 and receiver circuit 52, and is constituted so as to be capable of sending and receiving a signal bi-directionally to and from hard disk device 4.

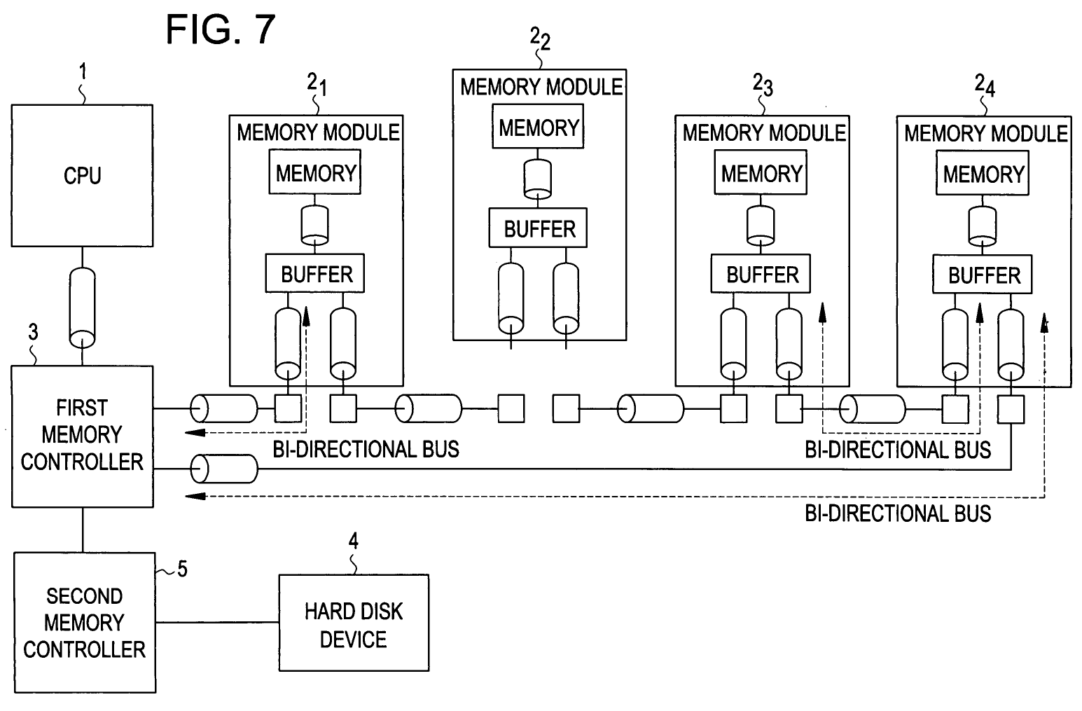

In this embodiment, the bus connecting the plurality of memory modules 2 and first memory controller 3 is used as a unidirectional bus at the time of a normal operation as shown in FIG. 4 and is used as a bi-directional bus at the time of hot swap of an arbitrary memory module (memory module 2₂ in FIG. 7) as shown in FIG. 7. Switching of these bus systems is realized by switching operations of buffer circuits 31 and 32 of each buffer section 300 in accordance with a control signal which is sent to buffer section 300 of each memory module 2 from CPU 1 via first controller 3.

In addition, in the case in which an access from CPU 1 to memory module 2 to be replaced due to a failure (hereinafter referred to as a failed memory module) is requested, CPU 1 accesses hard disk device 4 via second memory controller 5 instead of the failed memory module. Since data in all memory modules 2 are mirrored to hard disk device 4, hot swap of the failed memory module becomes possible.

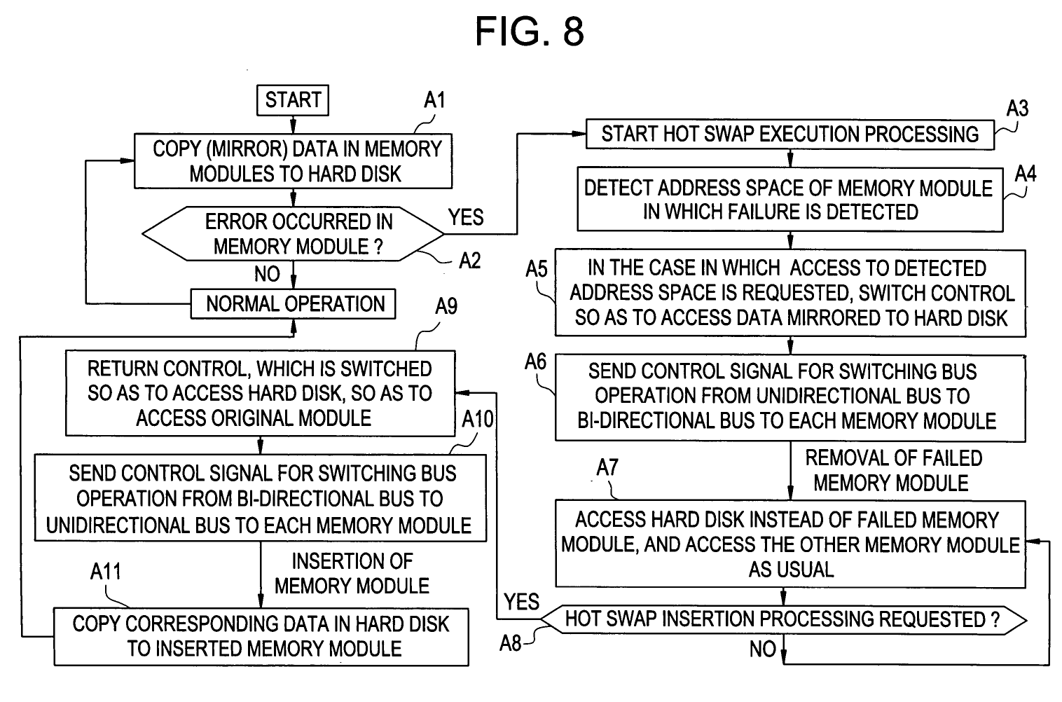

Next, an operation of the memory system of this embodiment will be described with reference to FIG. 8.

Note that, in the operation of the memory system described below, an example in which memory modules 2, first memory controller 3, and second memory controller 5 are controlled by CPU 1 provided in the information processing apparatus will be described. However, it is also possible to control the operation of the memory system with first memory controller 3 and second memory controller 5. In that case, first memory controller 3 and second memory controller 5 are constituted by a DSP or the like which executes processing described below in accordance with a command from CPU 1.

As shown in FIG. 8, at the time of the normal operation, CPU 1 copies data stored in each memory module 2 of the memory system to hard disk device 4 (mirroring) at each predetermined period (step A1). Subsequently, CPU 1 watches whether or not a failure has occurred in memory modules 2 (step A2) and, if a failure has not occurred, returns to the processing of step A1 to continue the mirroring processing for mirroring data to hard disk device 4.

In the case in which a failure has occurred in an arbitrary memory module 2, CPU 1 starts hot swap execution processing for making it possible to remove the failed memory module (step A3). The hot swap execution processing may be started, for example, in the case in which a predetermined command is supplied via an input device (a keyboard, a mouse, etc.) provided in the information processing apparatus, or the case in which a predetermined command is sent via a network or the like.

In the hot swap execution processing, first, CPU 1 detects an address space (memory area) of the failed memory module (step A4) and, in the case in which an access to the failed memory module is requested, switches its control to memory control via second memory controller 5 such that an access is made to the mirrored data in hard disk device 4 (step A5). In addition, CPU 1 sends a control signal for switching the bus operation from the unidirectional bus to the bi-directional bus to each memory module 2 via first memory controller 3 (step A6). Thereafter, as shown in FIG. 7, first memory controller 3 and the respective memory modules 2 perform transmission and reception of the data using a bus route bypassing the failed memory module.

When the failed memory module is removed, CPU 1 accesses hard disk device 4 via second memory controller 5 instead of the failed memory module in response to the request to access the memory module. In addition, in the case in which an access to any one of the other memory modules is requested, CPU 1 performs transmission and reception of data as usual using a bus route accessible to the memory module (step A7).

Next, in order to insert the memory module recovered from the failure (or a new memory module), CPU 1 confirms whether or not the start of hot swap insertion processing for making it possible to insert a memory module is requested (step A8). The hot swap insertion processing is started, for example, in the case in which a predetermined command is supplied via the input device provided in the information processing apparatus or the case in which a predetermined command is sent via a network or the like. In the case in which the hot swap insertion processing is not requested, CPU 1 returns to the processing of step A7 to continue the above-described processing at the time of hot swap.

In the case in which the start of the hot swap insertion processing is requested, first, CPU 1 switches the control, which was switched so as to access hard disk device 4, to the control for accessing the original memory module 2 (step A9). In addition, CPU 1 sends a control signal for switching the bus operation from the bi-directional bus to the unidirectional bus to first memory controller 3 (step A10). Then, when the memory module recovered from the failure (or new memory module) is inserted, CPU 1 copies data in hard disk device 4 corresponding to the failed memory module to the inserted memory module 2 (step A11) and shifts to the normal operation.

According to the constitution of this embodiment, even in the memory system in which the memory controller and the plurality of memory modules are connected in series in a ring shape, the hot swap function can be realized without increasing the number of memory modules.

(Second Embodiment)

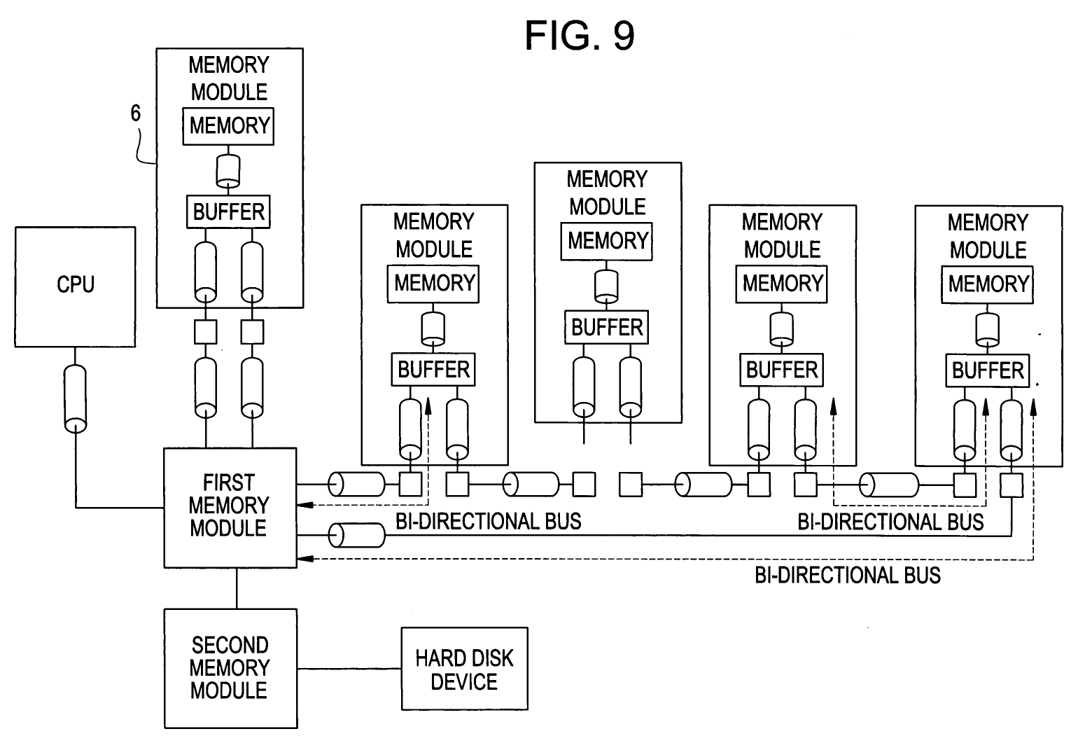

As shown in FIG. 9, a memory system of a second embodiment includes mirror memory module 6 for copying data in a failed memory module in addition to the memory system of the first embodiment shown in FIG. 4.

In the memory system of this embodiment, when an address space of a failed memory module is detected, mirrored data in a hard disk device corresponding to the detected address space is copied to mirror memory module 6. Then, in the case in which an access to the failed module is requested, mirror memory module 6 is accessed via a first memory controller. Moreover, at the time of insertion of a new memory module, data in mirror memory module 6 is copied to the hard disk device and the inserted memory module, respectively. Since the other components and operations are the same as those in the memory system of the first embodiment, descriptions of the components and operations will be omitted.

According to the memory system of this embodiment, the hot swap function can be realized. In addition, since mirror memory module 6, which is accessible at a high speed compared with the hard disk device, is accessed at the time when an access to the failed memory module is requested, time for accessing a memory area corresponding to the failed memory module can be reduced further compared with the first embodiment.

(Third Embodiment)

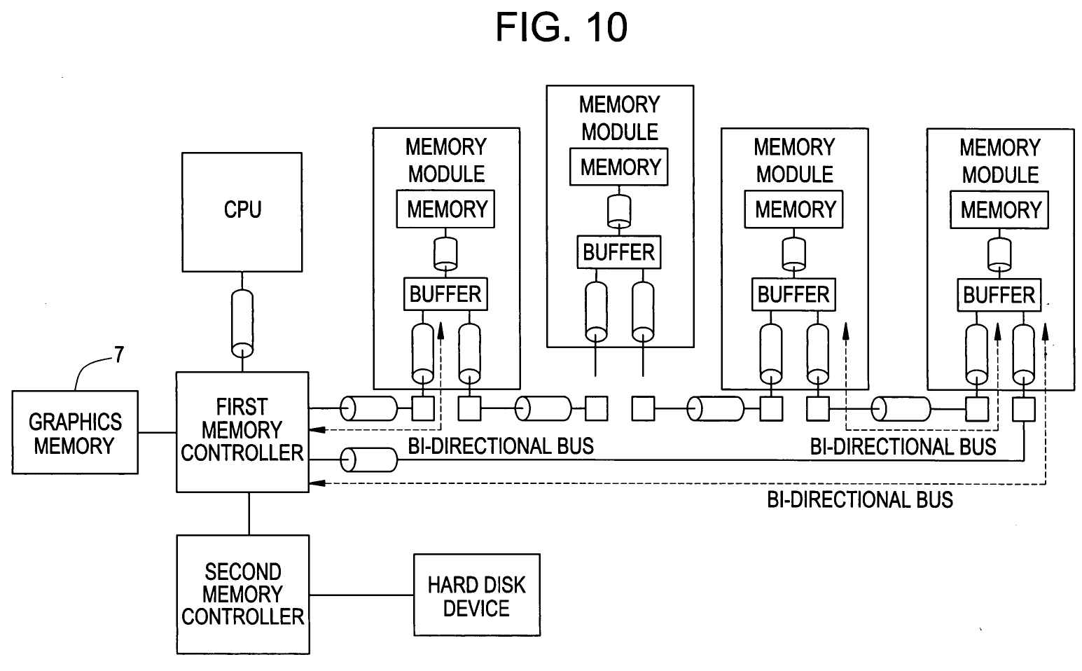

As shown in FIG. 10, a memory system of a third embodiment includes graphics memory 7 for copying data in a failed memory module in addition to the memory system of the first embodiment shown in FIG. 4. As graphics memory 7, it is sufficient to use one provided in an information processing apparatus in advance. The data in the failed memory module is copied to a free memory area of graphics memory 7.

In the memory system of this embodiment, when an address space of a failed memory module is detected, mirrored data in a hard disk device corresponding to the detected address space is copied to graphics memory 7. Then, in the case in which an access to the failed memory module is requested, graphics memory 7 is accessed via a first memory controller. Moreover, at the time of insertion of a new memory module, data in graphics memory 7 corresponding to the failed memory module is copied to the hard disk device and the inserted memory module, respectively. Since the other components and operations are the same as those in the memory system of the first embodiment, descriptions of the components and operations will be omitted.

In this embodiment, as in the second embodiment, the hot swap function can be realized. In addition, since graphics memory 7, which is accessible at a high speed compared with the hard disk device, is accessed at the time when an access to the failed memory module is requested, time for accessing a memory area corresponding to the failed memory module can be reduced further compared with the first embodiment.

(Fourth Embodiment)

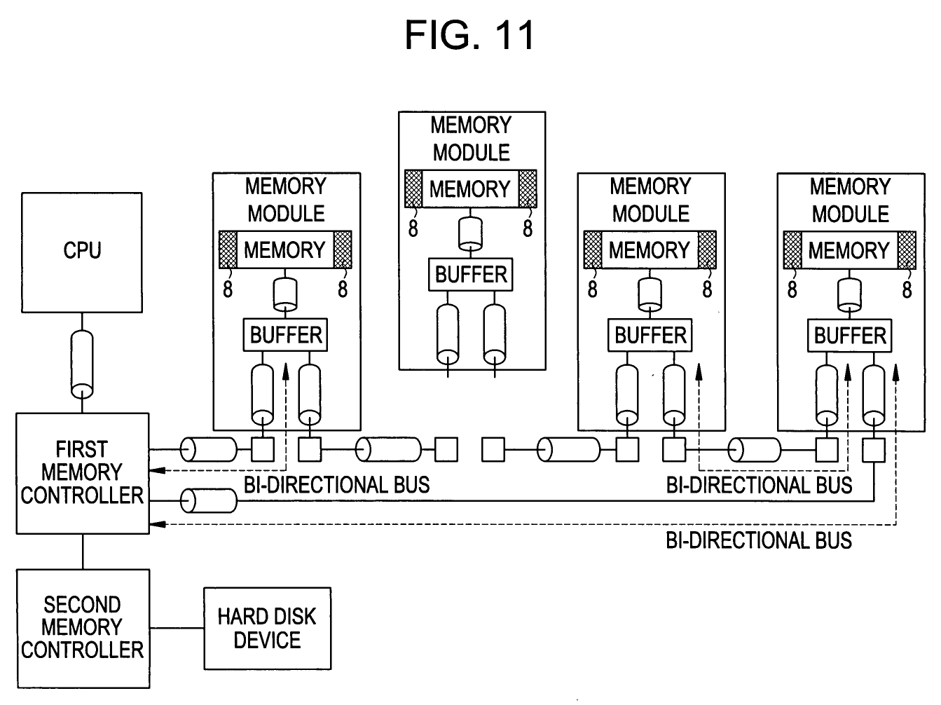

As shown in FIG. 11, in a memory system of a fourth embodiment, data in a failed memory module is copied to free memory areas 8 of semiconductor memories provided in the other memory modules in which a failure has not occurred.

In the memory system of this embodiment, when an address space of the failed memory module is detected, mirrored data in a hard disk device corresponding to the detected address space is dispersedly copied to free memory areas 8 of the memory modules in which a failure has not occurred. Then, in the case in which an access to the failed module is requested, free memory areas 8 of the memory modules in which a failure has not occurred are accessed via a first memory controller. Moreover, at the time of insertion of a new memory module, data in free memory areas 8 corresponding to the failed memory module is copied to the hard disk device and the inserted memory module, respectively. Since the other components and operations are the same as those in the memory system of the first embodiment, descriptions of the components and operations will be omitted.

In this embodiment, as in the second embodiment, the hot swap function can be realized. In addition, free memory area 8 of the memory module, which is accessible at a high speed compared with the hard disk device, is accessed at the time when an access to the failed memory module is requested, time for accessing a memory area corresponding to the failed memory module can be reduced further compared with the first embodiment.

(Fifth Embodiment)

In the first to the fourth embodiments, since the memory system is operated by the bi-directional bus at the time of hot swap, efficiency of use of the bus falls. In addition, since a portion where a memory module is removed becomes a bus end, it is likely that a transmission speed of a signal has to be decreased at the time of hot swap.

A memory system of a fifth embodiment is constituted to be capable of realizing the hot swap function and operable by a unidirectional bus even at the time of hot swap.

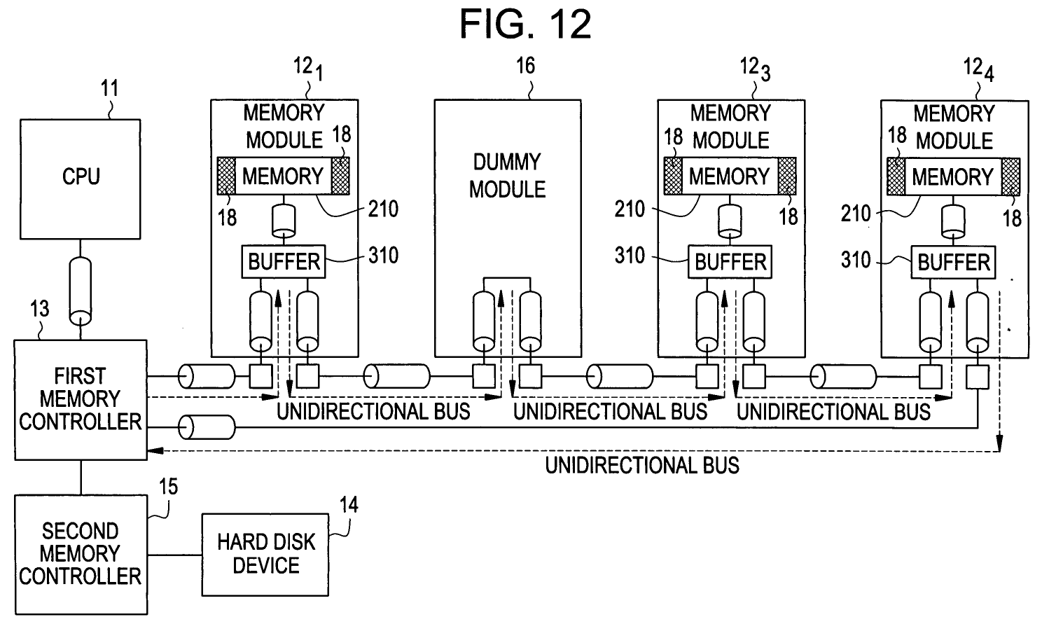

As shown in FIG. 12, the memory system of the fifth embodiment includes a plurality of (three in the figure) memory modules 12 (12₁, 12₃, 12₄), first memory controller 13 which controls an access operation from CPU 11 to memory modules 12, hard disk device 14 to which data in all memory modules 12 is copied (mirrored), and second memory controller 15 which controls an access operation from CPU 11 to hard disk device 14, in which memory modules 12 and first memory controller 13 are connected in series in a ring shape.

Memory modules 12 have a plurality of semiconductor memories 210 in which data is stored, and buffer sections 310 for sending and receiving a signal between a bus and semiconductor memory 210. In addition, in the memory system of this embodiment, dummy module 16 to be inserted in the memory system is provided instead of a failed memory module (not-shown memory module 12₂). FIG. 12 shows a structure in which the memory system has four memory modules 12 and dummy module 16 is inserted instead of not-shown memory module 12₂. However, the number of memory modules 12 is not limited to four, and any number of memory modules 12 may be provided. In addition, buffer sections 310 are not required to be provided independently but may be provided in semiconductor memories 210.

As shown in FIG. 12, dummy module 16 is provided with a short-circuit line for connecting adjacent two memory modules 12 (or memory modules 12 and first memory controller 13) to each other. Data in failed memory module 12₂ is dividedly copied to, for example, free memory areas 18 of the other memory modules 12₁, 12₃, and 12₄, in which a failure has not occurred, from mirrored hard disk device 14. Note that data in the failed memory module may be copied to a mirror memory module or a graphics memory from a hard disk device in the same manner as the second or the third embodiment.

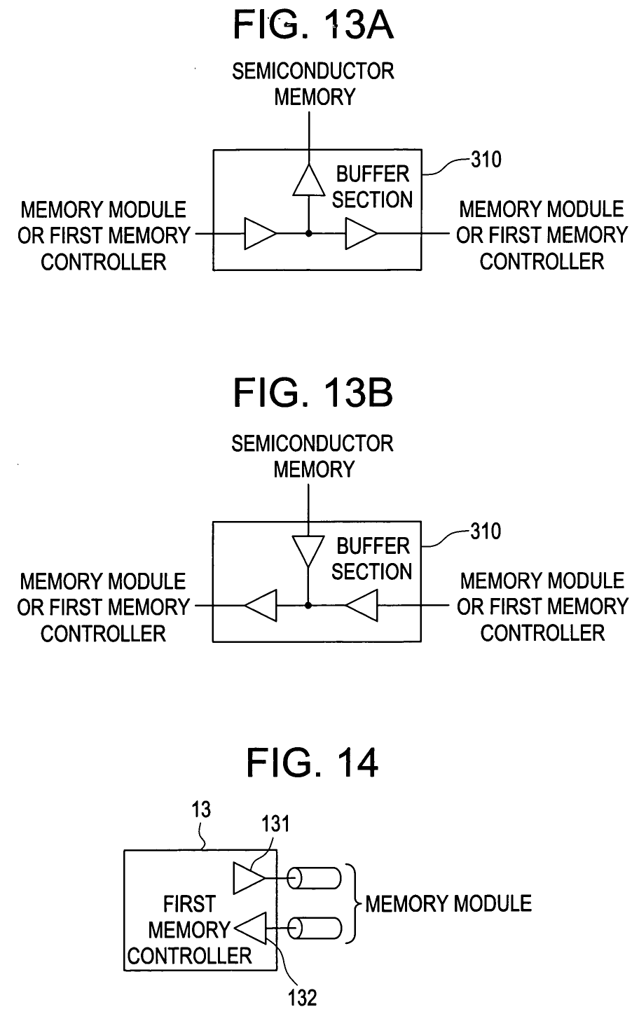

As shown in FIGS. 13A and 13B, buffer section 310 of this embodiment is provided with three buffer circuits, and is constituted so as to send and receive a signal unidirectionally to and from semiconductor memory 210 in a memory module, to which buffer section 310 belongs, and adjacent memory module 12 or first memory controller 13, respectively. FIG. 13A shows a structure of each buffer section 310 in the case in which a signal is transmitted in a direction of memory modules 12₁, 12₃, and 12₄ from first memory controller 13. FIG. 13B shows a structure of each buffer section 310 in the case in which a signal is transmitted in a direction of first memory controller 13 from memory modules 12₄, 12₃, and 12₁.

The memory system may have only one of a unidirectional bus connected in buffer section 310 shown in FIG. 13A and a unidirectional bus connected in buffer section 310 shown in FIG. 13B or may have both the unidirectional buses. In the structure having dummy module 16 of this embodiment, efficiency of use of the bus falls. However, the structure can also be applied to the case in which the memory system is operated by a bi-directional bus as in the first to the fourth embodiments. The hot swap function can also be realized by such a structure.

As shown in FIG. 14, first memory controller 13 of this embodiment includes driver circuit 131 for sending data to adjacent memory module 12 and receiver circuit 132 for receiving data from adjacent memory module 12. Second memory controller 15 is provided with a driver circuit and a receiver circuit with input ends and output ends thereof connected with each other as in the first embodiment, and is constituted to send and receive a signal bi-directionally to and from hard disk device 14 (FIGS. 6A and 6B).

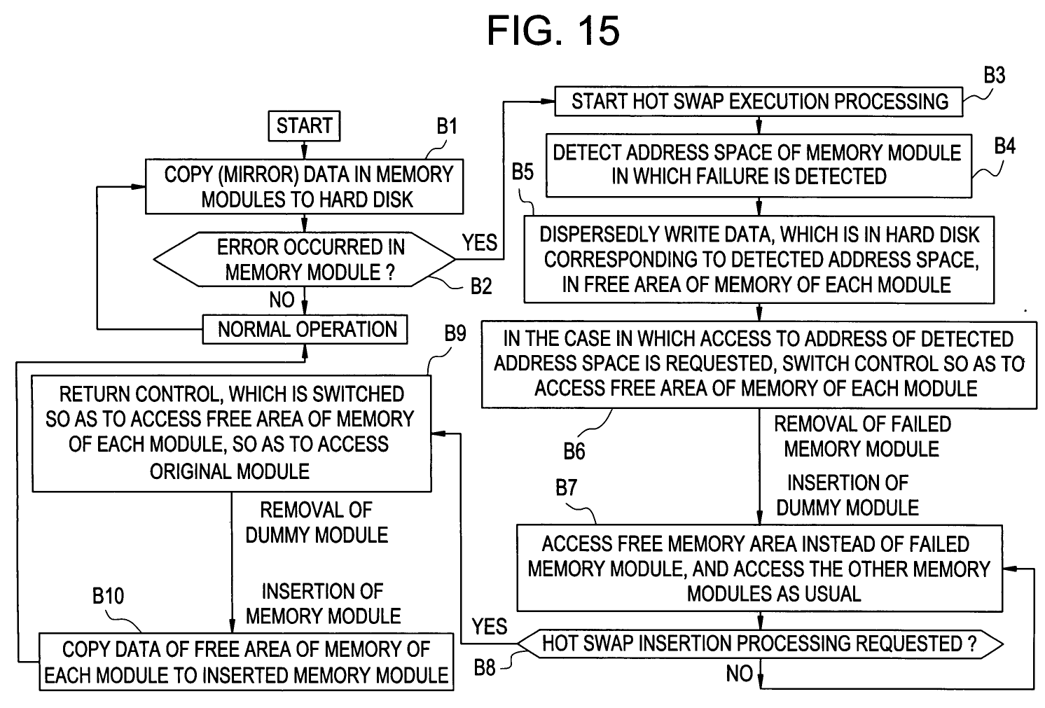

Next, an operation of the memory system of this embodiment will be described with reference to FIG. 15.

Note that, in the operation of the memory system described below, an example in which memory modules 12, first memory controller 13, and second memory controller 15 are controlled by CPU 11 provided in the information processing apparatus will be described. However, it is also possible to control the operation of the memory system with first memory controller 13 and second memory controller 15. In that case, first memory controller 13 and second memory controller 15 are constituted by a DSP or the like which executes processing described below in accordance with a predetermined command from CPU 11.

As shown in FIG. 15, at the time of the normal operation, CPU 11 copies (mirrors) data stored in each memory module 12 of the memory system to hard disk device 14 at each predetermined period (step B1). Subsequently, CPU 11 watches whether or not a failure has occurred in memory modules 12 (step B2) and, if a failure has not occurred, returns to the processing of step B1 to continue the mirroring processing for mirroring data to hard disk device 14.

In the case in which a failure has occurred in an arbitrary memory module 12, CPU 11 starts hot swap execution processing for making it possible to remove the failed memory module (step B3). The hot swap execution processing may be started in the case in which a predetermined command is input via the input device (a keyboard or a mouse, etc.) provided in the information processing apparatus or the case in which a predetermined command is sent via a network or the like.

In the hot swap execution processing, first, an address area (memory area) of the failed memory module 12 is detected (step B4), and dispersedly copies data in hard disk device 14 corresponding to the address space to free memory spaces 18 in the respective memory modules 12 in which a failure has not occurred (step B5).

In addition, CPU 11 switches memory control so as to access the mirrored data in the other memory modules 12 in response to a request to access the failed memory module 12 (step B6).

When the failed memory module 12 is removed and dummy module 16 is inserted instead of the failed memory module 12, thereafter, in the case in which an access to the failed memory module 12 is requested, CPU 11 accesses free memory area 18 of a corresponding memory module in which a failure has not occurred using the unidirectional bus. In addition, in the case in which an access to the memory module in which a failure has not occurred is requested, CPU 11 sends and receives data as usual to and from the memory module using the unidirectional bus (step B7).

Next, in order to insert the memory module recovered from the failure (or a new memory module), CPU 11 confirms whether or not the start of hot swap insertion processing for making it possible to insert a memory module is requested (step B8). The hot swap insertion processing is started, for example, in the case in which a predetermined command is supplied via the input device provided in the information processing apparatus or the case in which a predetermined command is sent via a network or the like. In the case in which the hot swap insertion processing is not requested, CPU 11 returns to the processing of step B7 to continue the above-described processing at the time of hot swap.

In the case in which the start of the hot swap insertion processing is requested, first, CPU 11 switches the control, which was switched so as to access free memory area 18 of memory module 12, to the control for accessing the original memory module 12 (step B9). Then, when dummy module 16 is removed and the memory module 12 recovered from the failure (or a new memory module) is inserted instead of dummy module 16, CPU 11 copies data in each memory module corresponding to the address space of the failed memory module to the inserted memory module 12 (step B10) and shifts to the normal operation.

According to the constitution of this embodiment, the hot swap function can be realized. In addition, since the free memory area of the memory module in which a failure has not occurred, which is accessible at a high speed compared with the hard disk device, is accessed at the time when an access to the failed memory module is requested, time for accessing a memory area corresponding to the failed memory module can be reduced further compared with the first embodiment. Moreover, since the memory system can be operated by the unidirectional bus even at the time of hot swap, efficiency of use of the bus is prevented from falling.

(Sixth Embodiment)

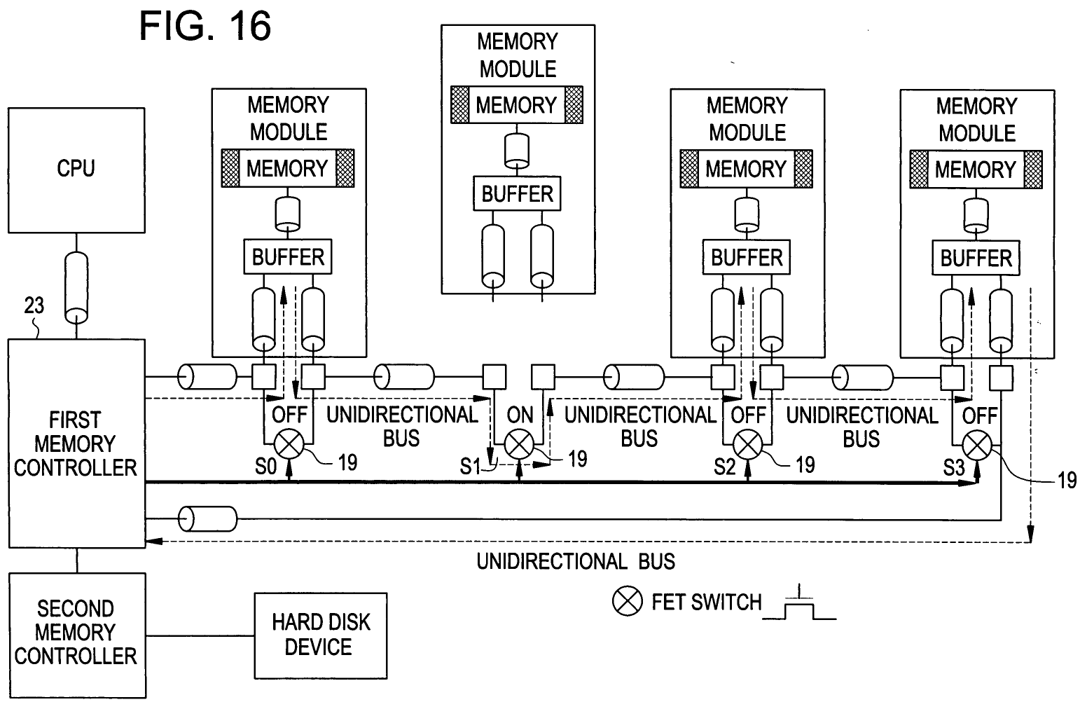

As shown in FIG. 16, a memory system of sixth embodiment includes FET switches 19 for connecting or opening a bus for adjacent two memory modules (or a memory module and a first memory controller) in connecting parts of respective memory modules and the bus, respectively, instead of the dummy module described in the fifth embodiment.

As in the fifth embodiment, data in a failed memory module is copied to, for example, free memory areas of the other memory modules in which a failure has not occurred from a hard disk device. The data in the failed memory module may be copied to a mirror memory module or a graphics memory from the hard disk device as in the second or the third embodiment.

In addition, as in the fifth embodiment, the memory system of this embodiment may have only one of the unidirectional buses connected in buffer section 310 shown in FIG. 13A and the unidirectional bus connected in buffer section 310 shown in FIG. 13B, or may have both the unidirectional buses. In the structure having FET switches 19 of this embodiment, efficiency of use of the bus falls. However, the structure can also be applied to the case in which the memory system is operated by a bi-directional bus as in the first to the fourth embodiments. With such a structure, the hot swap function can also be realized. Moreover, the buffer section provided in the memory module is not required to be provided independently but may be provided in the semiconductor memory.

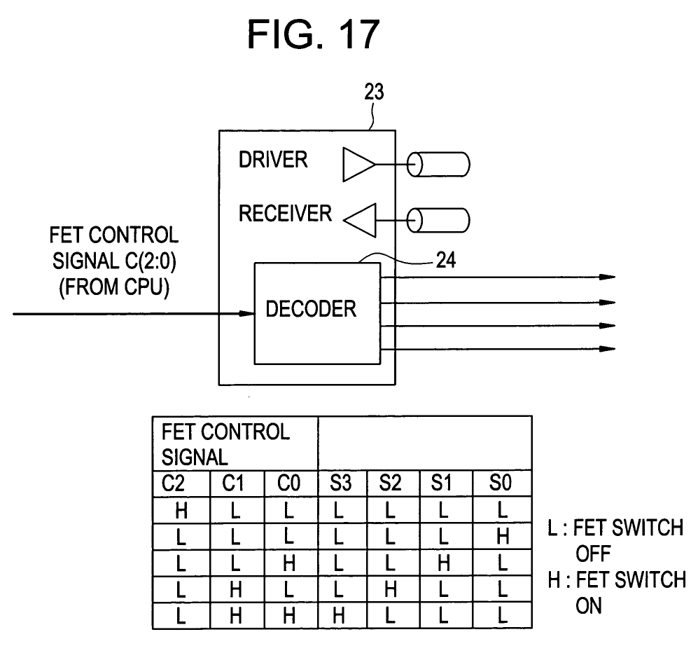

As shown in FIG. 17, first memory controller 23 of this embodiment has decoder 24 which decodes an FET control signal sent from a CPU and turns on/off an FET switch provided for each memory module. Decoder 24 turns on FET switch 19 corresponding to a failed memory module in accordance with the FET control signal, and turns off FET switches 19 corresponding to the memory modules in which a failure has not occurred. FIG. 17 shows an example in which the memory system includes four memory modules and decodes an FET control signal C [2:0] of three bits sent from the CPU to thereby control on/off of four FET switches S0 to S4. It is sufficient to set the number of bits and the number of decodes of the FET control signal appropriately in association with the number of memory modules.

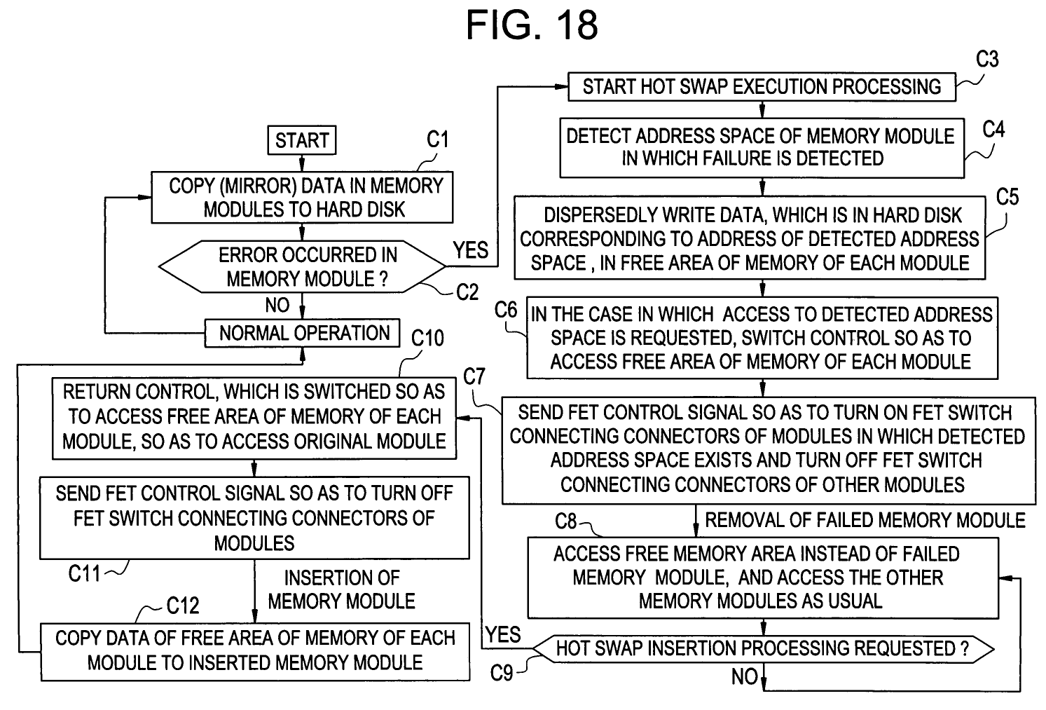

Next, an operation at the time of hot swap of the memory system of this embodiment will be described with reference to FIG. 18.

Note that the operation of the memory system described below will be described with the case in which the memory modules and the first and second memory controllers are controlled by a CPU provided in an information processing apparatus as an example. However, it is also possible to control the operation of the memory system with the first and second memory controllers. In that case, the first and the second memory controllers are constituted by a DSP or the like which executes processing described below in accordance with a predetermined command.

As shown in FIG. 18, at the time of the normal operation, the CPU copies data stored in each memory module of the memory system to the hard disk device (mirroring) at each predetermined period (step C1). Then, the CPU watches whether or not a failure has occurred in each memory modules (step C2) and, if a failure has not occurred, returns to the processing of step C1 to continue the mirroring of the data in each memory module to the hard disk device.

In the case in which a failure has occurred in an arbitrary memory module, the CPU starts hot swap execution processing for making it possible to remove the failed memory module (step C3). The hot swap execution processing may be started, for example, in the case in which a predetermined command is supplied via an input device (a keyboard, a mouse, etc.) provided in the information processing apparatus or in the case in which a predetermined command is sent via a network or the like.

In the hot swap execution processing, first, the CPU detects an address space (memory area) of the failed memory module (step C4) and dispersedly copies data in the hard disk device corresponding to the memory area to the free memory spaces in the respective memory modules in which a failure has not occurred (step C5). In addition, the CPU switches memory control so as to access the mirrored data in the other memory modules in response to a request to access the failed memory module (step C6).

Moreover, the CPU sends an FET control signal for turning on FET switch 19 corresponding to the failed memory module and turning off FET switches 19 corresponding to the memory modules in which a failure has not occurred to the first memory controller (step C7).

When the failed memory module is removed, thereafter, in the case in which an access to the failed memory module is requested, the CPU accesses the free memory area of a corresponding memory module in which a failure has not occurred using the unidirectional bus. In addition, in the case in which an access to the memory module in which a failure has not occurred is requested, the CPU sends and receives data as usual to and from the memory module using the unidirectional bus (step C8).

Next, in order to insert the memory module recovered from the failure (or a new memory module), the CPU confirms whether or not the start of hot swap insertion processing for making it possible to insert a memory module is requested (step C9). The hot swap insertion processing is started, for example, in the case in which a predetermined command is supplied via the input device provided in the information processing apparatus or the case in which a predetermined command is sent via a network or the like. In the case in which the hot swap insertion processing is not requested, the CPU returns to the processing of step C8 to continue the above-described processing at the time of hot swap.

In the case in which the start of the hot swap insertion processing is requested, first, the CPU switches the control, which was switched so as to access the free memory area of the memory module, to the control for accessing the original memory module (step C10). In addition, the CPU sends an FET control signal for turning off FET switches 19 corresponding to all the memory modules to first memory controller 23 (step C11). Then, when the memory module recovered from the failure (or a new memory module) is inserted, the CPU copies data in the free memory area of each memory module corresponding to the address space in which the failure was detected to the inserted memory module (step C12) and shifts to the normal operation.

According to the constitution of this embodiment, as in the fifth embodiment, the hot swap function can be realized. In addition, since the free memory area of the memory module in which a failure has not occurred, which is accessible at a high speed compared with the hard disk device, is accessed at the time when an access to the failed memory module is requested, time for accessing a memory area corresponding to the failed memory module can be reduced further compared with the first embodiment. Moreover, since the memory system can be operated by the unidirectional bus even at the time of hot swap, efficiency of use of the bus is prevented from falling.

(Seventh Embodiment)

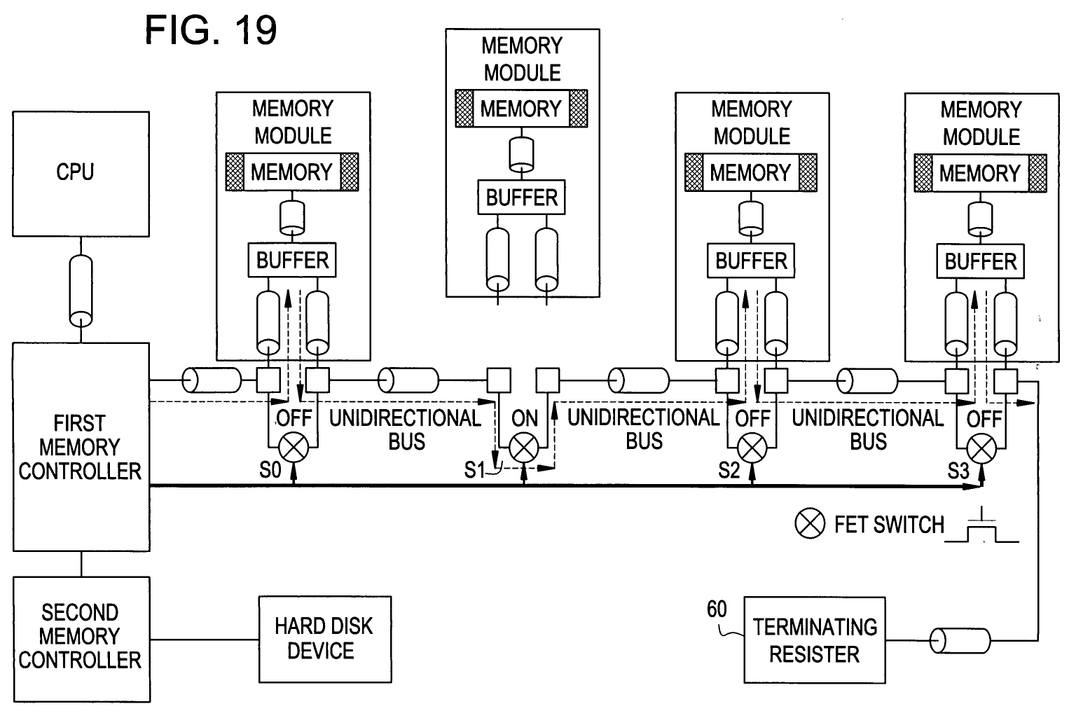

As shown in FIG. 19, a memory system of a seventh embodiment has a structure in which the ring of the bus connecting the first memory controller and the plurality of memory modules described in the sixth embodiment is disconnected and the bus end is terminated in terminating resistor 60 or the like. FIG. 19 shows a structure provided with a unidirectional bus in which data is transmitted in the direction of the memory modules from the first memory controller. However, a unidirectional bus in which data is transmitted in the direction of the first memory controller from the memory modules may be provided, or these two kinds of unidirectional buses may be provided, respectively. In addition, in the structure having FET switches of this embodiment, efficiency of use of the bus falls. However, the structure can also be applied to the case in which the memory system is operated by the bi-directional bus as in the first to the fourth embodiment. With such a structure, the hot swap function can also be realized. Since the other components and operations at the time of the hot swap are the same as those in the memory system of the sixth embodiment, descriptions of the components and operations will be omitted.

According to this embodiment, even with the memory system in which the memory controller and the plurality of memory modules are not connected in a ring shape but connected in series by a bus as shown in FIG. 19, the hot swap function can be realized, and time for accessing a memory area corresponding to a failed memory module at the time of hot swap can be reduced as in the fifth embodiment. Moreover, since the memory system is operated by the unidirectional bus even at the time of hot swap, efficiency of use of the bus is prevented from falling.

(Eighth Embodiment)

As shown in FIG. 20, a memory system of an eighth embodiment includes connectors 70 provided with short pins 71 for short-circuiting adjacent two memory modules (or a memory module and a first memory controller) at the time when the memory module is removed instead of the FET switch described in the seventh and the eighth embodiments.

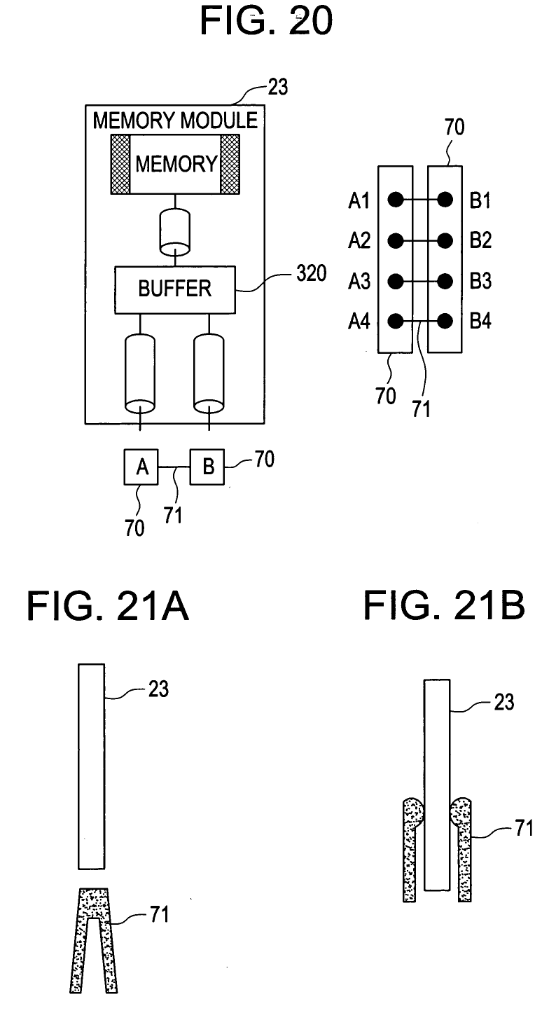

The short pins 71 are arranged opposedly on connectors 70 so as to short-circuit each other when there is no memory module between them as shown in FIG. 21A. The short-circuit is released by the memory module when it is inserted between them as shown in FIG. 21B.

Data in a failed memory module is copied from a hard disk device to, for example, free memory areas of the other memory modules in which a failure has not occurred. The data in the failed memory module may be copied from the hard disk device to a mirror memory module or a graphics memory in the same manner as the second embodiment or the third embodiment.

In addition, as in the fifth embodiment, the memory system of this embodiment may have only one of a unidirectional bus connected in buffer section 310 shown in FIG. 13A and a unidirectional bus connected in buffer section 310 shown in FIG. 13B, or may have both the unidirectional buses. In addition, in the structure having the short pins 71 of this embodiment, efficiency of use of the bus falls. However, the structure can also be applied to the case in which the memory system is operated by a bi-directional bus as in the first to the fourth embodiments. The hot swap function can also be realized by such a structure. Moreover, the buffer sections provided in the memory modules are not required to be provided independently but may be provided in the semiconductor memories.

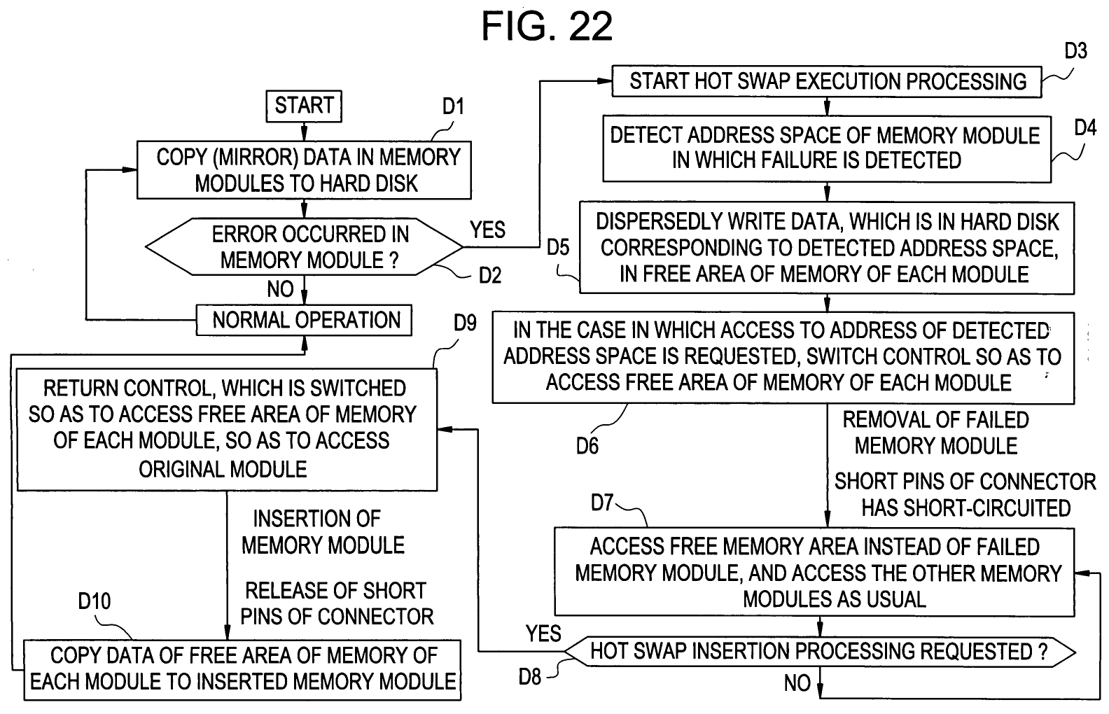

Next, an operation at the time of hot swap of the memory system of this embodiment will be described with reference to FIG. 22.

Note that the operation of the memory system described below will be described with the case in which the memory modules and the first and the second memory controllers are controlled by the CPU provided in the information processing apparatus as an example. However, it is also possible to control the operation of the memory system with the first and the second controllers. In that case, the first and the second memory controllers are constituted by a DSP or the like which executes processing described below in accordance with a predetermined command.

As shown in FIG. 22, at the time of the normal operation, the CPU copies data stored in each memory module of the memory system to the hard disk device (mirroring) at each predetermined period (step D1). Subsequently, the CPU watches whether or not a failure has occurred in each memory modules (step D2) and, if a failure has not occurred, returns to the processing of step D1 to continue the mirroring of data of each memory module to the hard disk device.

In the case in which a failure has occurred in an arbitrary memory module, the CPU starts hot swap execution processing for making it possible to remove the failed memory module (step D3). The hot swap execution processing may be started, for example, in the case in which a predetermined command is supplied via an input device (a keyboard, a mouse, etc.) provided in the information processing apparatus or in the case in which a predetermined command is sent via a network or the like.

In the hot swap execution processing, first, the CPU detects an address space (memory area) of the failed memory module (step D4) and dispersedly copies data in the hard disk device corresponding to the memory area to the free memory spaces in the respective memory modules in which a failure has not occurred (step D5). In addition, the CPU switches memory control so as to access the mirrored data in the other memory modules in response to a request to access the failed memory module (step D6).

When the short pins 71 short-circuit by removing the failed memory module, in the case in which an access to the failed memory module is requested, the CPU accesses a free memory area of a corresponding memory module in which a failure has not occurred using the unidirectional bus. In addition, in the case in which an access to the memory module in which a failure has not occurred is requested, the CPU performs transmission and reception of data as usual to and from the memory module using the unidirectional bus (step D7).

Next, in order to insert the memory module recovered from the failure (or a new memory module), the CPU confirms whether or not the start of hot swap insertion processing for making it possible to insert a memory module is requested (step D8). The hot swap insertion processing is started, for example, in the case in which a predetermined command is supplied via the input device provided in the information processing apparatus or the case in which a predetermined command is sent via a network or the like. In the case in which the hot swap insertion processing is not requested, the CPU returns to the processing of step D7 to continue the above-described processing at the time of hot swap.

In the case in which the start of the hot swap insertion processing is requested, first, the CPU switches the control, which was switched so as to access the free memory area of the memory module, to the control for accessing the original memory module (step D9). Then, when the memory module has recovered from the failure (or a new memory module) is inserted and the short-circuit of the short pins is released, the CPU copies data in the free memory area of each memory module corresponding to the address space in which the failure was detected to the inserted memory module (step D10) and shifts to the normal operation.

According to the constitution of this embodiment, as in the fifth embodiment, the hot swap function can be realized. In addition, since the free memory area of the memory module in which a failure has not occurred, which is accessible at a high speed compared with the hard disk device, is accessed at the time when an access to the failed memory module is requested, time for accessing a memory area corresponding to the failed memory module can be reduced further compared with the first embodiment. Moreover, since the memory system can be operated by the unidirectional bus even at the time of hot swap, efficiency of use of the bus is prevented from falling.

While preferred embodiments of the present invention have been described using specific terms, such description is for illustrative purposes only, and it is to be understood that changes and variations may be made without departing from the spirit or scope of the following claims.

What is claimed is:

1. A memory system comprising:
a plurality of memory modules provided with memory areas for holding data and buffer sections for sending and receiving the data;
a hard disk device to which the data stored in said memory modules is copied;
a control device for, in replacing an arbitrary memory module, switching said bus from a unidirectional bus capable of sending and receiving a signal unidirectionally to a bi-directional bus capable of sending and receiving a signal bi-directionally, detecting an address space of said memory module to be replaced, and accessing a memory area in said hard disk device corresponding to the detected address space at the time when an access to said memory module to be replaced is requested; and
a CPU which controls said control device for access operation to said memory modules,
wherein said buffer sections are connected in series to form a ring bus with said control device, each having a buffer circuit for causing said bus to operate as said unidirectional bus or said bi-directional bus in accordance with an instruction from said control device.

2. A memory system comprising:
a plurality of memory modules provided with memory areas for holding data and buffer sections for sending and receiving the data;
a hard disk device to which the data stored in said memory modules is copied;
a storage to which data stored in an arbitrary memory module is temporarily copied;
a control device for, in replacing an arbitrary memory module, switching said bus from a unidirectional bus capable of sending and receiving a signal unidirectionally to a bi-directional bus capable of sending and receiving a signal bi-directionally, detecting an address space of said memory module to be replaced, copying data corresponding to the detected address space from said hard disk device to said storage, and accessing a memory area in said storage corresponding to the detected address space at the time when an access to said memory module to be replaced is requested; and
a CPU which controls said control device for access operation to said memory modules,
wherein said buffer sections are connected in series to form a ring bus with said control device, each having a buffer circuit for causing said bus to operate as said unidirectional bus or said bi-directional bus in accordance with an instruction from said control device.

3. The memory system according to claim 1, further comprising a short-circuit device for, when an arbitrary memory module is replaced, recovering bus connection which is disconnected by removing said memory module.

4. The memory system according to claim 2, further comprising a short-circuit device for, when an arbitrary memory module is replaced, recovering bus connection which is disconnected by removing said memory module.

5. A memory system comprising:
a plurality of memory modules provided with memory areas for holding data and buffer sections for sending and receiving the data;
a hard disk device to which the data stored in said memory modules is copied;
a storage to which data stored in an arbitrary memory module is temporarily copied;
a short-circuit device for, in replacing an arbitrary memory module, recovering bus connection which is disconnected by removing said memory module to be replaced;
a control device for, in replacing an arbitrary memory module, detecting an address space of said memory module to be replaced, copying data corresponding to the detected address space from said hard disk device to said storage, and accessing a memory area in said storage corresponding to the detected address space at the time when an access to said memory module to be replaced is requested; and
a CPU which controls said control device for access operation to said memory modules,
wherein said buffer sections are connected in series to form a unidirectional bus capable of sending and receiving a signal unidirectionally.

6. The memory system according to claim 3, wherein said short-circuit device is a dummy module which is inserted instead of said memory module to be replaced and is provided with a short-circuit line for short-circuiting bus connection which is disconnected by removing said memory module.

7. The memory system according to claim 4, wherein said short-circuit device is a dummy module which is inserted instead of said memory module to be replaced and is provided with a short-circuit line for short-circuiting bus connection which is disconnected by removing said memory module.

8. The memory system according to claim 5, wherein said short-circuit device is a dummy module which is inserted instead of said memory module to be replaced and is provided with a short-circuit line for short-circuiting bus connection which is disconnected by removing said memory module.

9. The memory system according to claim 3, wherein said short-circuit device is an FET switch, which is provided in association with said memory modules, respectively, for short-circuiting or opening bus connection which is disconnected by removing said memory module, and
in replacing an arbitrary memory module, said control device generates a control signal for turning ON the FET switch provided in association with said memory module to be replaced and turning OFF the FET switches provided in association with the other memory modules.

10. The memory system according to claim 4, wherein said short-circuit device is an FET switch, which is provided in association with said memory modules, respectively, for short-circuiting or opening bus connection which is disconnected by removing said memory module, and
in replacing an arbitrary memory module, said control device generates a control signal for turning ON the FET switch provided in association with said memory module to be replaced and turning OFF the FET switches provided in association with the other memory modules.

11. The memory system according to claim 5, wherein said short-circuit device is an FET switch, which is provided in association with said memory modules, respectively, for short-circuiting or opening bus connection which is disconnected by removing said memory module, and
in replacing an arbitrary memory module, said control device generates a control signal for turning ON the FET switch provided in association with said memory module to be replaced and turning OFF the FET switches provided in association with the other memory modules.

12. The memory system according to claim 3, wherein said short-circuit device is a connector, which is provided in association with said memory modules, respectively, and is provided with short pins which short-circuits bus connection, which is disconnected by removing said memory module, at the time when said memory module is removed, and releases the short-circuit at the time when said memory module is inserted.

13. The memory system according to claim 4, wherein said short-circuit device is a connector, which is provided in association with said memory modules, respectively, and is provided with short pins which short-circuits bus connection, which is disconnected by removing said memory module, at the time when said memory module is removed, and releases the short-circuit at the time when said memory module is inserted.

14. The memory system according to claim 5, wherein said short-circuit device is a connector, which is provided in association with said memory modules, respectively, and is provided with short pins which short-circuits bus connection, which is disconnected by removing said memory module, at the time when said memory module is removed, and releases the short-circuit at the time when said memory module is inserted.

15. The memory system according to claim 2, wherein said storage is a memory module for mirror which is provided with a memory area for holding data and a buffer section for sending and receiving data.

16. The memory system according to claim 5, wherein said storage is a memory module for mirror which is provided with a memory area for holding data and a buffer section for sending and receiving data.

17. The memory system according to claim 2, wherein said storage is a memory for graphics.

18. The memory system according to claim 5, wherein said storage is a memory for graphics.

19. The memory system according to claim 2, wherein said storage is free memory areas of the other memory modules excluding said memory module to be replaced.

20. The memory system according to claim 5, wherein said storage is free memory areas of the other memory modules excluding said memory module to be replaced.

21. A control method for a memory system which has a plurality of memory modules provided with memory areas for holding data and buffer sections for sending and receiving the data,
wherein said buffer sections are connected in series to form a ring bus with a control device which controls an operation for accessing memory modules, said method comprising the steps of:
copying the data stored in said memory modules to a hard disk device at each predetermined period;
in replacing an arbitrary memory module, switching said bus from a unidirectional bus capable of sending and receiving a signal unidirectionally to a bi-directional bus capable of sending and receiving a signal bi-directionally;
detecting an address space of said memory module to be replaced; and
accessing a memory area in said hard disk device corresponding to the detected address space at the time when an access to said memory module to be replaced is requested.

22. A control method for a memory system which has a plurality of memory modules provided with memory areas for holding data and buffer sections for sending and receiving the data,
wherein said buffer sections are connected in series to form a ring bus with a control device which controls an operation for accessing memory modules, said method comprising the steps of:
copying the data stored in said memory modules to a hard disk device at each predetermined period;
in replacing an arbitrary memory module, switching said bus from a unidirectional bus capable of sending and receiving a signal unidirectionally to a bi-directional bus capable of sending and receiving a signal bi-directionally;
detecting an address space of said memory module to be replaced;
copying data corresponding to the detected address space from said hard disk device to a storage; and
accessing a memory area in said storage corresponding to the detected address space at the time when an access to said memory module to be replaced is requested.

23. A control method for a memory system which has a plurality of memory modules provided with memory areas for holding data and buffer sections for sending and receiving the data,
wherein said buffer sections are connected in series to form a unidirectional bus capable of sending and receiving a signal unidirectionally, said method comprising the steps of:
copying the data stored in said memory modules to a hard disk device at each predetermined period;
in replacing an arbitrary memory module, short-circuiting bus connection which is disconnected by removing said memory module to be replaced;
detecting an address space of said memory module to be replaced;
copying data corresponding to the detected address space from said hard disk device to a storage; and
accessing a memory area in said storage corresponding to the detected address space at the time when an access to said memory module to be replaced is requested.

24. The control method for a memory system according to claim 21, further comprising the step of:
in replacing an arbitrary memory module, inserting a dummy module provided with a short-circuit line for short-circuiting a bus, which is disconnected by removing said memory module, instead of said memory module to be replaced.

25. The control method for a memory system according to claim 22, further comprising the step of:
in replacing an arbitrary memory module, inserting a dummy module provided with a short-circuit line for short-circuiting a bus, which is disconnected by removing said memory module, instead of said memory module to be replaced.

26. The control method for a memory system according to claim 23, further comprising the step of:
in replacing an arbitrary memory module, inserting a dummy module provided with a short-circuit line for short-circuiting a bus, which is disconnected by removing said memory module, instead of said memory module to be replaced.

27. The control method for a memory system according to claim 21, further comprising the step of:
in replacing an arbitrary memory module, turning ON an FET switch, which is provided in association with said memory module to be replaced, for short-circuiting or opening a bus which is disconnected by removing said memory module, and turning OFF said FET switch provided in association with the other memory modules.

28. The control method for a memory system according to claim 22, further comprising the step of:
in replacing an arbitrary memory module, turning ON an FET switch, which is provided in association with said memory module to be replaced, for short-circuiting or opening a bus which is disconnected by removing said memory module, and turning OFF said FET switch provided in association with the other memory modules.

29. The control method for a memory system according to claim 23, further comprising the step of:
in replacing an arbitrary memory module, turning ON an FET switch, which is provided in association with said memory module to be replaced, for short-circuiting or opening a bus which is disconnected by removing said memory module, and turning OFF said FET switch provided in association with the other memory modules.

30. The control method for a memory system according to claim 21, further comprising the step of:
in replacing an arbitrary memory module, short-circuiting short pins, which are provided in a connector corresponding to said memory module to be replaced, for short-circuiting or opening a bus which is disconnected by removing said memory module to be replaced, and releasing the short-circuit of said short pins provided in association with the other memory modules.

31. The control method for a memory system according to claim 22, further comprising the step of:
in replacing an arbitrary memory module, short-circuiting short pins, which are provided in a connector corresponding to said memory module to be replaced, for short-circuiting or opening a bus which is disconnected by removing said memory module to be replaced, and releasing the short-circuit of said short pins provided in association with the other memory modules.

32. The control method for a memory system according to claim 23, further comprising the step of:
in replacing an arbitrary memory module, short-circuiting short pins, which are provided in a connector corresponding to said memory module to be replaced, for short-circuiting or opening a bus which is disconnected by removing said memory module to be replaced, and releasing the short-circuit of said short pins provided in association with the other memory modules.

33. The control method for a memory system according to claim 22, wherein said storage is a memory for mirror provided with a memory area for holding data and a buffer section for sending and receiving data.

34. The control method for a memory system according to claim 23, wherein said storage is a memory for mirror provided with a memory area for holding data and a buffer section for sending and receiving data.

35. The control method for a memory system according to claim 22, wherein said storage is a memory for graphics.

36. The control method for a memory system according to claim 23, wherein said storage is a memory for graphics.

37. The control method for a memory system according to claim 22, wherein said storage is free memory areas of the other memory modules excluding said memory module to be replaced.

38. The control method for a memory system according to claim 23, wherein said storage is free memory areas of the other memory modules excluding said memory module to be replaced.
